(19) United States
(12) Patent Application Publication
(10) Pub. No.: US 2025/0370397 A1
(43) Pub. Date: Dec. 4, 2025

(54) IMAGE FORMING APPARATUS

(71) Applicant: CANON KABUSHIKI KAISHA, Tokyo (JP)

(72) Inventor: RYOICHI KAWASUMI, Ibaraki (JP)

(21) Appl. No.: 19/221,812

(22) Filed: May 29, 2025

(30) Foreign Application Priority Data
May 31, 2024 (JP) 2024-088701

(51) Int. Cl. G03G 15/00; G03G 21/16

(52) U.S. Cl. CPC G03G 15/80; G03G 21/1633; G03G 21/1652; G03G 2215/00978; G03G 2221/166

(57) ABSTRACT

An image forming apparatus includes a power supply fixed to a casing, a power inlet configured to supply, to the power supply, electric power supplied from an outside via a power cord, and an inlet support member to which the power inlet is fixed, wherein the power supply includes an electric board configured to be supplied with the electric power from the power inlet, and a board support member configured to support the electric board, and wherein the power inlet is fixed to the board support member through intermediation of the inlet support member.

### BACKGROUND

### Field of the Technology

The present disclosure relates to an image forming apparatus including an electric component portion.

### Description of the Related Art

An image forming apparatus such as a copying machine or a printer includes electric component portions on a back surface or a side surface. The electric component portions include, for example, various electric boards and cables, bundled wires, and harnesses for connecting the electric boards to each other. Examples of the electric boards include a control board for controlling image formation, a high-voltage board for generating a high voltage at the time of image formation, and a drive board for controlling sheet conveyance. In Japanese Patent Application Laid-open No. 2002-031924, there is disclosed an image forming apparatus in which a power supply board (power supply unit) is arranged in a back surface space of a casing. A cable for supplying external electric power is connected to the power supply unit from a power inlet arranged in the casing.

The cable for connecting the power inlet and the power supply unit to each other becomes long depending on the positional relationship therebetween. In this case, a distance between a support member for the power inlet and the power supply unit is also increased. The power inlet is fixed and grounded to the casing of the image forming apparatus by the support member. In a case where the distance between the support member for the power inlet and the power supply unit is increased, a ground potential from the power inlet to the power supply unit becomes unstable. The unstable ground potential causes generation of a noise in the electric power supplied from the outside. The noise of the electric power supplied from the outside becomes a noise of electric power supplied from the power supply unit to another electric component portion, and affects a stable operation of the another electric component portion.

### SUMMARY

An image forming apparatus according to some embodiments of the present disclosure includes a power supply fixed to a casing, a power inlet configured to supply, to the power supply, electric power supplied from an outside via a power cord, and an inlet support member to which the power inlet is fixed, wherein the power supply includes an electric board configured to be supplied with the electric power from the power inlet, and a board support member configured to support the electric board, and wherein the power inlet is fixed to the board support member through intermediation of the inlet support member. An image forming apparatus according to another embodiment of the present disclosure includes a power supply fixed to a casing, and a power inlet configured to supply, to the power supply, electric power supplied from an outside via a power cord, wherein the power supply includes an electric board configured to be supplied with the electric power from the power inlet, and a board support member configured to support the electric board, and wherein the power inlet is fixed to the board support member.

Features of the present disclosure will become apparent from the following description of embodiments with reference to the attached drawings. The following description of embodiments are described by way of example.

### BRIEF DESCRIPTION OF THE DRAWINGS

FIG. 1 is a configuration view for illustrating an image forming apparatus.

FIG. 2 is an explanatory view for illustrating an arrangement of electric component portions of the image forming apparatus.

FIG. 3 is an explanatory view for illustrating an arrangement of electric component portions of an image forming apparatus.

FIG. 4A and FIG. 4B are explanatory views for illustrating power supply paths.

FIG. 5 is a configuration view for illustrating a power supply unit and an inlet support member.

FIG. 6 is an explanatory view for illustrating a configuration of a power cord.

FIG. 7 is an explanatory view for illustrating the configuration of the power cord.

FIG. 8 is an explanatory view for illustrating the configuration of the power cord.

FIG. 9 is a cross-sectional view taken along the line A-A of FIG. 5.

### DESCRIPTION OF THE EMBODIMENTS

Now, referring to the accompanying drawings, description is given of at least one exemplary embodiment of the present disclosure.

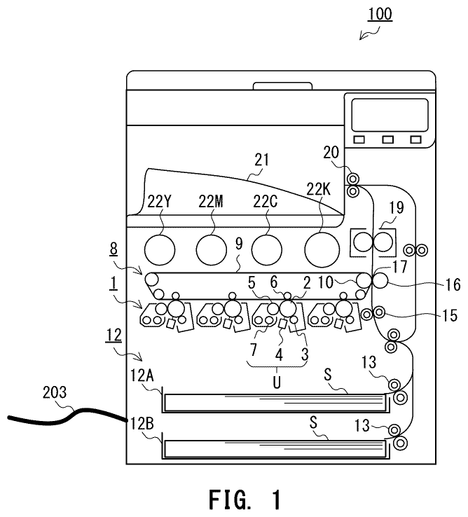

FIG. 1 is a configuration view for illustrating an image forming apparatus of the at least one embodiment. An image forming apparatus 100 of the at least one embodiment is a four-full-color laser printer employing a tandem-intermediate transfer system using an electrophotographic process. The image forming apparatus 100 forms an image on a sheet S based on image information input to a control circuit portion (not shown) from an external device (not shown) such as a personal computer.

The image forming apparatus 100 includes an image forming portion 1 arranged substantially at a middle in a casing. The image forming portion 1 is used to form toner images of four colors of yellow (Y), magenta (M), cyan (C), and black (K). The image forming portion 1 includes four image forming units U corresponding to the respective colors. The four image forming units U have a substantially common configuration. Description is given here of a configuration of an image forming unit U forming a cyan toner image, and description of configurations of image forming units U forming toner images of the other colors is omitted.

The image forming unit U includes a drum unit including a rotary-drum type electrophotographic photosensitive member (hereinafter referred to as “drum”) 2 serving as an image bearing member, and a developing unit including a developing sleeve 5 for developing a toner image. The drum unit and the developing unit can be replaced or can be mounted to and removed from the image forming apparatus 100.

The drum unit includes, in addition to the drum 2, a charging roller 3 for charging the drum 2, and a drum cleaner portion (not shown). The developing unit includes, in addition to the developing sleeve 5, a screw 7 for stirring toner and supplying the stirred toner to the developing sleeve 5. An exposure unit 4 including a light emitting element such as a light emitting diode (LED) is arranged between the drum unit and the developing unit.

An intermediate transfer belt unit 8 is provided on an upper side of the image forming portion 1, and a sheet cassette 12 is provided on a lower side of the image forming portion 1. The intermediate transfer belt unit 8 includes: four primary transfer rollers 6 arranged so as to be opposed to the drums 2 corresponding to the respective colors; a belt drive roller 10; and a belt 9. The sheet cassette 12 includes two cassettes, specifically, a cassette 12A arranged in an upper stage and a cassette 12B arranged in a lower stage.

Toner bottles 22Y, 22M, 22C, and 22K corresponding to the respective colors are arranged on the upper side of the intermediate transfer belt unit 8. The toner bottles 22Y, 22M, 22C, and 22K store replenishing toners for the respective developing units of the four image forming units U. The toner bottles 22Y, 22M, 22C, and 22K can be mounted and removed for replacement. An appropriate amount of toner is supplied at an appropriate timing by a toner supplying mechanism (not shown) from each of the toner bottles 22Y, 22M, 22C, and 22K corresponding to the respective developing units of the four image forming units U.

In an image forming process, electrostatic latent images are required to be formed on the respective drums 2 of the four image forming units U. As a preparation operation therefor, a high voltage is applied to the charging roller 3 brought into pressure contact with the drum 2 so that the surface of the rotating drum 2 is uniformly charged. The light emitting element of the exposure unit 4 irradiates the uniformly charged surface of the drum 2 with light (for example, laser light). The potential of the surface of the drum 2 is a value that varies between a position irradiated with light and a position not irradiated with light. This difference allows the electrostatic latent image to be formed on the surface of the drum 2.

A high voltage is applied to the developing sleeve 5 in a path different from the path of applying a high voltage to the charging roller 3 so that the surface of the developing sleeve 5 is uniformly coated with charged toner in the developing unit. In the developing unit, the toner is circulated and conveyed by the screw 7 at high speed. The rotation speed of the screw 7 is very high relative to the rotation speeds of the developing sleeve 5 and the drum 2. Accordingly, the developing sleeve 5 is uniformly coated with toner without unevenness. The toner on the developing sleeve 5 adheres to the electrostatic latent image, to be developed. Thus, a toner image is formed on the drum 2.

The toner images of the respective colors formed on the respective drums 2 are primarily transferred in a sequential manner onto the surface of the belt 9 rotated in the counterclockwise direction of FIG. 1 by the belt drive roller 10. In the at least one embodiment, toner images are transferred in the order of yellow, magenta, cyan, and black. In this manner, the toner images of the respective colors are formed in a superimposed manner on the belt 9.

The image forming apparatus 100 has, on the right side of the image forming portion 1 as viewed from the front side, a sheet conveyance path provided for conveying the sheet S from the lower side to the upper side. On the sheet conveyance path, in the order from the lower side toward the upper side, a sheet feeding roller pair 13, a registration roller pair 15, a secondary transfer roller 16, a fixing device 19, and a discharge roller pair 20 are provided. The secondary transfer roller 16 is brought into abutment against the belt drive roller 10 of the intermediate transfer belt unit 8 across the belt 9 at a predetermined pressing force, and forms a secondary transfer nip portion 17 between the secondary transfer roller 16 and the belt 9.

The sheet feeding roller pair 13 is driven at a predetermined control timing according to the image forming process, and separates and feeds the sheets S one by one from the sheet cassette 12. The fed sheet S is conveyed to the registration roller pair 15 through the sheet conveyance path. The registration roller pair 15 corrects the skew feeding of the sheet S, and conveys the sheet S to the secondary transfer nip portion 17 in synchronization with the timing at which the toner images transferred onto the belt 9 are conveyed to the secondary transfer nip portion 17.

The secondary transfer nip portion 17 nips and conveys the belt 9 and the sheet S. The secondary transfer nip portion 17 secondarily transfers the toner images of the four colors formed on the belt 9 onto the sheet S in a collective manner. In this manner, unfixed toner images are formed on the sheet S. The sheet S is conveyed from the secondary transfer nip portion 17 to the fixing device 19. The fixing device 19 applies heat and pressure to the sheet S having the toner images formed thereon, to fix the toner images to the sheet S. The sheet S having the toner images fixed thereon by the fixing device 19 is discharged, as a product of image formation, by the discharge roller pair 20 to a discharge tray 21 provided above the toner bottles 22Y, 22M, 22C, and 22K.

A power cord 203 is provided to the image forming apparatus 100 on the left side of the casing as viewed from the front side. The image forming apparatus 100 is operated by electric power supplied from an external power supply (for example, commercial power supply) via the power cord 203.

### <Power Supply Unit>

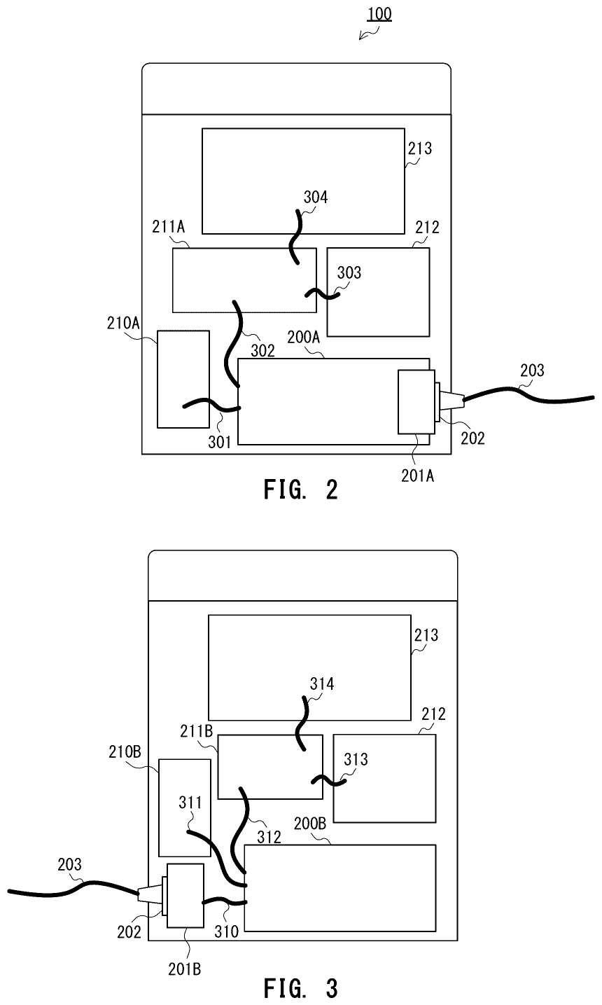

FIG. 2 is an explanatory view for illustrating an arrangement of electric component portions of the image forming apparatus 100 of the at least one embodiment. FIG. 2 shows the image forming apparatus 100 as viewed from the back surface side. In the image forming apparatus 100, the electric component portions including a plurality of electric boards for use in forming an image on the sheet S are provided. Examples of the electric component portions include: control boards 211A and 213 for controlling the image forming process; a high-voltage board 212 for generating bias voltages to be used at the time of charging, primary transfer, secondary transfer, and the like; a conveyance drive board 210A for controlling conveyance of the sheet S; and a power supply unit 200A. In the casing of the image forming apparatus 100, the power supply unit 200A is provided at a lowermost portion, the conveyance drive board 210A is provided next to the power supply unit 200A, the high-voltage board 212 and the control board 211A are provided above the power supply unit 200A, and the control board 213 is provided at an uppermost portion.

The power supply unit 200A supplies DC power to each of the electric boards of the electric component portions. Accordingly, bundled wires 301 for supplying the DC power to the conveyance drive board 210A and bundled wires 302 for supplying the DC power to the control board 211A are connected to the power supply unit 200A. The supply of the DC power to the high-voltage board 212 is performed by bundled wires 303 connecting the control board 211A and the high-voltage board 212 to each other, via the bundled wires 302 and the control board 211A. The supply of the DC power to the control board 213 is performed by bundled wires 304 connecting the control board 211A and the control board 213 to each other, via the bundled wires 302 and the control board 211A.

A plate-shaped inlet support member 201A to which a power inlet 202 is fixed is fixed to the power supply unit 200A by a screw. The power inlet 202 is arranged at a position at which the power cord 203 can be directly inserted and pulled out from the outer side of the casing of the image forming apparatus 100. With the power cord 203 being inserted to the power inlet 202 and a plug side of the power cord 203 being connected to an outlet, electric power can be supplied from the external power supply to the power supply unit 200A. AC power supplied from the outlet is converted to DC power by the power supply unit 200A. The DC power is supplied to the electric component portions (electric boards) via the bundled wires 301, 302, 303, and 304. FIG. 3 is an explanatory view for illustrating the arrangement of the electric component portions of the related-art image forming apparatus. Most arrangement of the electric boards is similar to that in FIG. 2, but FIG. 3 is greatly different from FIG. 2 in that an inlet support unit 201B including the power inlet 202 is arranged in the vicinity of a power supply unit 200B as a single unit independent of the power supply unit 200B. In this manner, a conveyance drive board 210B is arranged higher than the conveyance drive board 210A of FIG. 2, and a control board 211B is arranged to be closer to the middle than the control board 211A of FIG. 2.

The reason therefor is because, in a case where the inlet support unit 201B is arranged as a single unit, the power supply unit 200B and the conveyance drive board 210B cannot be accommodated at the same height in the lateral direction of the image forming apparatus 100. The power supply unit 200B has a heat generation amount larger than those of other boards, and is required to dissipate heat by providing a predetermined space around the installation position. Further, in order to prevent compromising the ease of assembly of the bundled wires to be connected to the board, the boards are required to be arranged without overlapping other units. Accordingly, in a case where the power supply unit 200B and the inlet support unit 201B are accommodated at the same height in the lateral direction of the image forming apparatus 100, it becomes difficult to arrange other boards at this height.

For example, in a case where the power cord 203 is provided on the right side of FIG. 3 similarly to FIG. 2, the conveyance drive board 210B is required to be arranged at a position further higher than the position of FIG. 3 so as to avoid the power supply unit 200B. Accordingly, the conveyance drive board 210B, the high-voltage board 212, and the control board 211B are arranged laterally side by side. This arrangement narrows the space between the electric boards, and leads to reduction in size of the electric board itself. Accordingly, in the related-art configuration illustrated in FIG. 3, the power cord 203 is provided on the left side of FIG. 3, the conveyance drive board 210B is arranged higher than the conveyance drive board 210A of FIG. 2, and the control board 211B is arranged closer to the middle than the control board 211A of FIG. 2.

The AC power supplied from the outside via the power cord 203 is supplied from the inlet support unit 201B to the power supply unit 200B via a cable 310. The power supply unit 200B supplies the DC power converted from the AC power, to the electric component portions (electric boards) via bundled wires 311, 312, 313, and 314.

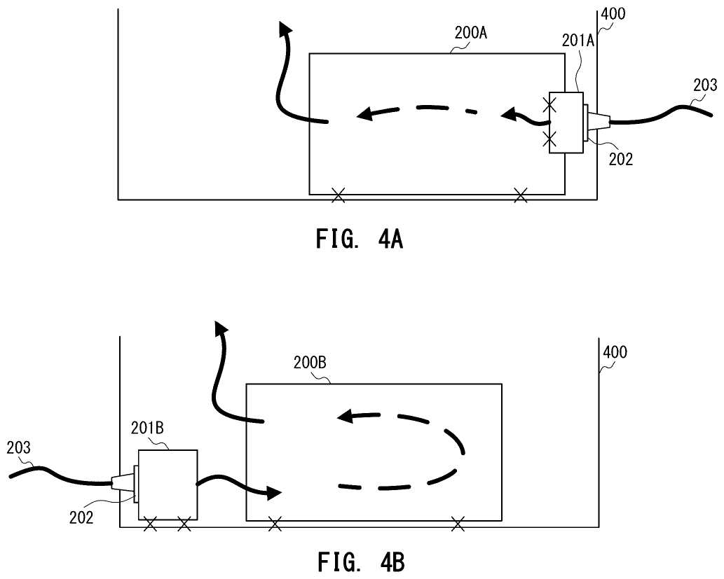

FIG. 4A and FIG. 4B are explanatory views for illustrating power supply paths of the at least one embodiment and the related art. FIG. 4A shows a power supply path obtained by the power supply unit 200A in the at least one embodiment. FIG. 4B shows a power supply path obtained by the power supply unit 200B in the related art.

As illustrated in FIG. 4A, the inlet support member 201A is fixed to the power supply unit 200A in the at least one embodiment at a plurality of screw fixing points indicated by “x”. The power supply unit 200A is fixed to a casing 400 of the image forming apparatus 100 at a plurality of screw fixing points indicated by “x” similarly to the foregoing. A plurality of screw fixing points are provided in order to stabilize the ground potential of the power supply unit 200A.

The supply of the AC power to the power supply unit 200A is performed via the power cord 203 and the power inlet 202. The power supply unit 200A converts the AC power to the DC power in a path on the electric board indicated by the broken line. The DC power converted by the power supply unit 200A is supplied to another electric component portion (another electric board). As described above, it is understood that the power supply path is formed in one direction from the right to the left of FIG. 4A, and is almost the shortest.

As illustrated in FIG. 4B, the power supply unit 200B and the inlet support unit 201B in the related art are fixed to the casing 400 at the screw fixing points indicated by “x”. The inlet support unit 201B is interposed in the power supply path provided from the outside. The number of screw fixing points of the inlet support unit 201B is the same as that in FIG. 4A, but the connection destination is not the power supply unit 200B but the casing 400.

The inlet support unit 201B is arranged on the left side of the power supply unit 200B. This arrangement means that the electric power is supplied to the power supply unit 200B from the left side. The power supply path is a path indicated by the broken line that makes a U-turn in the electric board of the power supply unit 200B, and passes a right end of the power supply unit 200B to return leftward. The power supply unit 200B converts the AC power to the DC power in this path. The DC power converted by the power supply unit 200B is supplied to another electric component portion (another electric board).

In FIG. 4B, the power supply path is long, and the distance between a grounding point of the power inlet 202 and a grounding point of the power supply unit 200B is long. Further, bundled wires interposed in the power supply path reaching the another electric component portion are also long. Accordingly, in the configuration of FIG. 4B, a noise is easily generated in the DC power and the control signal. That is, the configuration of the power supply unit 200A in the at least one embodiment illustrated in FIG. 4A is more noise resistant than the configuration of the power supply unit 200B in the related art illustrated in FIG. 4B.

### <Fastening of Inlet Support Member>

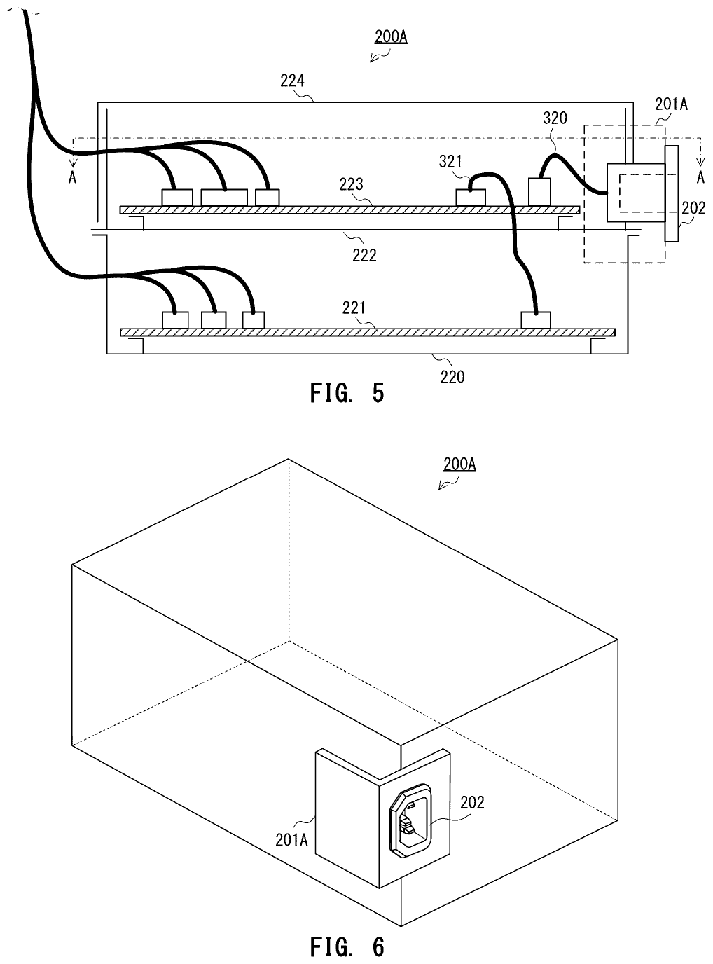

FIG. 5 is a configuration view for illustrating the power supply unit 200A and the inlet support member 201A. FIG. 5 shows the power supply unit 200A as viewed from the back surface side of the apparatus. The inlet support member 201A is illustrated in a transparent state, and its position is indicated by the broken line.

The power supply unit 200A includes two electric boards (power supply boards 221 and 223). The middle-speed or high-speed image forming apparatus 100 that has high productivity and many options such as sheet feeding and sheet discharging consumes a large amount of power. Thus, the power supply unit 200A is larger in scale than the power supply unit provided in a low-speed apparatus. In the power supply unit 200A, the two power supply boards 221 and 223 are arranged for the purpose of securing an arrangement area for components to be mounted. One of the power supply boards 221 and 223 is, for example, an AC driver board, and another one thereof is a low-voltage power supply board. The AC driver board converts the AC power to the DC power. The low-voltage power supply board generates, from a DC voltage converted by the AC driver board, a low-voltage driving voltage that can be used for the operation of another electric component portion (another electric board).

The power supply board 221 is supported by a plate-shaped board support member 220, and the power supply board 223 is supported by a board support member 222. The power supply unit 200A is formed as a compact unit with its height being reduced by horizontally stacking the board support member 220, the power supply board 221, the board support member 222, and the power supply board 223 in the stated order, and finally covering the stack with a power supply cover 224. The power supply board 221 and the board support member 220 are fixed to each other by screws, and the power supply board 223 and the board support member 222 are fixed to each other by screws. The board support member 220 and the board support member 222 are fixed to the casing of the power supply unit 200A at a plurality of points by screws in order to stabilize the ground potential. The power supply unit 200A is fixed to the casing 400 of the image forming apparatus 100 by screws. Accordingly, the casing 400 of the image forming apparatus 100, the board support members 220 and 222, and the power supply boards 221 and 223 are commonly grounded, and the ground potential is stable.

The fixing of the inlet support member 201A is performed by, as described with reference to FIG. 4A, fixing the inlet support member 201A to the casing of the power supply unit 200A at a plurality of points by screws. The inlet support member 201A is fastened to both of the board support members 220 and 222. The board support members 220 and 222 are each a sheet metal. The inlet support member 201A is brought close to and directly fixed to the power supply unit 200A (board support members 220 and 222), and hence the power supply unit 200A and the inlet support member 201A are commonly grounded, and the ground potential is stable.

### <Inlet Support Plate>

FIG. 6 to FIG. 8 are explanatory views for illustrating the configuration of the power cord 203. FIG. 6 to FIG. 8 are perspective views for illustrating the power supply unit 200A, and exemplify a state in which the power cord 203 is inserted to the power inlet 202.

FIG. 6 shows the power inlet 202 in a state in which the power cord 203 is not inserted. The general power cord 203 is only inserted to the power inlet 202, and a lock member for fixing the power cord 203 to the power inlet 202 is not provided. Accordingly, there is a possibility that an accident occurs such as a user erroneously pulling out the power cord 203 from the power inlet 202 by, for example, being tripped over the power cord 203.

In a case where the power cord 203 comes off from the power inlet 202 while the image forming apparatus 100 is in operation, the supply of the electric power is stopped, and hence the image forming operation and the sheet conveyance operation are forcibly interrupted. Accordingly, there is a possibility that an accident occurs such as temperature rise in the apparatus due to fan stop, toner flying into the apparatus, and damage on or falling off of the component due to jam processing for the sheet S.

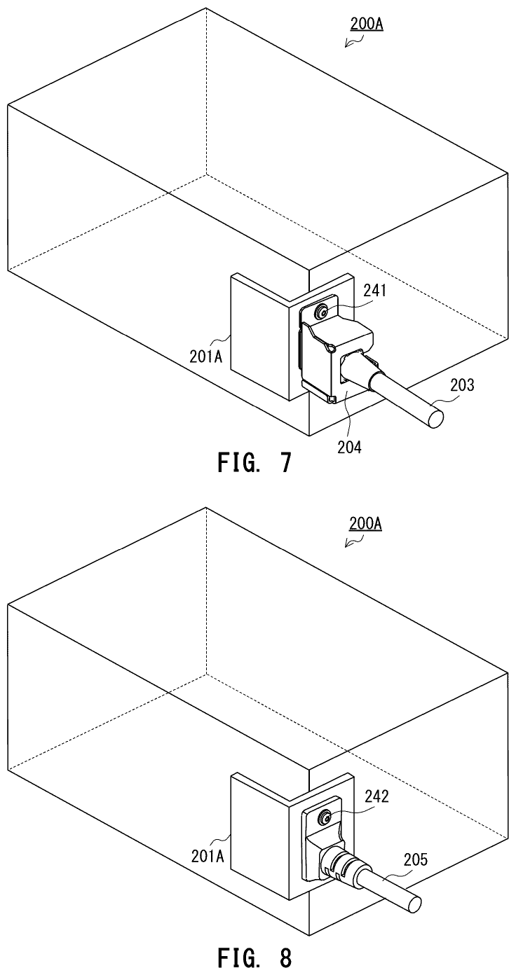

Thus, it is preferred that the power cord 203 do not easily come off from the power inlet 202. FIG. 7 shows a configuration in which the power cord 203 is prevented from coming off from the power inlet 202 by a plate-shaped code fixing member 204. The code fixing member 204 is fixed to the inlet support member 201A by a screw 241 under a state in which the code fixing member 204 holds the vicinity of an inlet insertion portion of the power cord 203. Accordingly, the power cord 203 is locked by the code fixing member 204 and does not come off even when a force acts in a pulling direction.

The power cord 203 may be directly fixed to the inlet support member 201A by a screw. In FIG. 8, a power cord 205 is directly fixed to the inlet support member 201A by a screw 242. In this case, the code fixing member 204 as illustrated in FIG. 7 is unrequired. In any case, the power cords 203 and 205 are fixed to the power inlet 202 through use of a fixing member such as a screw.

As described above, the power cord 203 is prevented from coming off from the power inlet 202. In order to prove that the power cord 203 does not come off from the power inlet 202, a pulling test of the power cord 203 is performed as part of electrical evaluation. The pulling test is performed by pulling the power cord 203 with a force having a predetermined margin to the force at the time of pulling out the power cord 203 in a state of not being fixed by the fixing member. For example, in the pulling test, the power cord 203 is pulled in forward, rearward, rightward, leftward, upward, and downward directions by the force of 20 N, and it is checked whether or not the power cord 203 comes off from the power inlet 202.

The power cord 203 is fastened to the casing 400 via the inlet support member 201A and the board support members 220 and 222. The force applied by the pulling test directly acts on those support plates, in particular, the inlet support member 201A. Thus, in order to prevent deformation from being caused by those external forces, the inlet support member 201A has a sufficient rigidity.

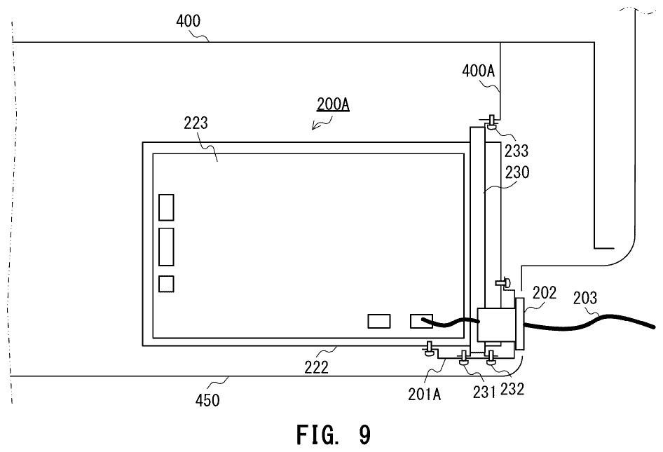

FIG. 9 is a cross-sectional view taken along the line A-A of FIG. 5, and shows the power supply board 223 as viewed from above. With reference to FIG. 9, description is given of a reinforcement configuration of the inlet support member 201A for preventing deformation from being caused by the force of the pulling test of the power cord 203.

The power supply unit 200A is arranged on the front side (lower side in FIG. 9) of the casing 400. From the casing 400, a screw fixing seat surface 400A protrudes like a tower in the direction toward the power supply unit 200A. The power supply unit 200A includes a reinforcing stay 230 therein. The reinforcing stay 230 is provided at a position close to the power inlet 202 in the power supply unit 200A, and extends in the front-back direction of the power supply unit 200A (up-down direction in FIG. 9). The reinforcing stay 230 has one end fixed to the inlet support member 201A by screws 231 and 232, and another end fixed to the screw fixing seat surface 400A of the casing 400 by a screw 233. With such a configuration, the rigidity in the vicinity of the power inlet 202 of the power supply unit 200A is improved by the reinforcing stay 230. The inlet support member 201A is fixed to the casing 400 via the reinforcing stay 230, and hence a sufficient rigidity is ensured. The deformation of the inlet support member 201A is suppressed even when external forces are applied in the upward, downward, rightward, and leftward directions.

Components having sensitivity to rigidity improvement against the external forces to the inlet support member 201A are mainly three components, specifically, the inlet support member 201A itself, the reinforcing stay 230, and the board support member 220 including a fastening portion between the power supply unit 200A and the casing 400. Thus, with the plate thickness of the board support member 222 being set relatively thinner than the plate thicknesses of those three components, the cost can be reduced.

In the image forming apparatus 100 having the configuration as described above, the power supply unit 200A and the power inlet 202 are close to each other, and hence the ground potential is stable. Accordingly, generation of a noise of electric power supplied to the power supply unit 200A is suppressed. Further, a noise of electric power supplied from the power supply unit 200A to another electric component portion can also be reduced. Accordingly, the operation of the electric component portion becomes stable. The control signal input to each electric component portion also becomes stable, and thus the operation of the image forming apparatus 100 also becomes stable.

Description has been given above of the configuration in which the power inlet 202 is fixed to the inlet support member 201A, and the inlet support member 201A is fixed to the board support member 222. With such configuration, electric power is supplied from the power inlet 202 to the power supply unit 200A. In a case where the power inlet 202 has such a shape that the power inlet 202 can be fixed to the board support member 222, or the power inlet 202 and the board support member 222 have a shape of being integrated with each other, the power inlet 202 may be directly fixed to the board support member 222 without intermediation of the inlet support member 201A.

In this case, the power inlet 202 is fixed to the casing of the power supply unit 200A at a plurality of points by screws. Further, the power inlet 202 is fastened to each of the board support members 220 and 222. The power inlet 202 is close to and is directly fixed to the power supply unit 200A (board support members 220 and 222), and hence the power supply unit 200A and the power inlet 202 are commonly grounded, and the ground potential is stable. Accordingly, even in a configuration in which the power inlet 202 is directly fixed to the board support member 222 without intermediation of the inlet support member 201A, the effects as described above can be obtained.

In any case, as long as the power inlet 202 is provided close to the power supply unit 200A and can supply electric power to the power supply unit 200A, the power inlet 202 may be directly fixed to the board support member 222 or may be indirectly fixed through intermediation of the inlet support member 201A.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-088701, filed May 31, 2024, which is hereby incorporated by reference herein in its entirety.

What is claimed is:

1. An image forming apparatus, comprising:
a power supply fixed to a casing;
a power inlet configured to supply, to the power supply, electric power supplied from an outside via a power cord; and
an inlet support member to which the power inlet is fixed,
wherein the power supply includes:
an electric board configured to be supplied with the electric power from the power inlet; and
a board support member configured to support the electric board, and
wherein the power inlet is fixed to the board support member through intermediation of the inlet support member.

2. An image forming apparatus, comprising:
a power supply fixed to a casing; and
a power inlet configured to supply, to the power supply, electric power supplied from an outside via a power cord,
wherein the power supply includes:
an electric board configured to be supplied with the electric power from the power inlet; and
a board support member configured to support the electric board, and
wherein the power inlet is fixed to the board support member.

3. The image forming apparatus according to claim 1,
wherein the power supply includes a reinforcing stay,
wherein the casing includes a fixing seat surface to which the reinforcing stay is allowed to be fixed, and
wherein the inlet support member is fixed to the reinforcing stay.

4. The image forming apparatus according to claim 3,
wherein the reinforcing stay is fixed to the fixing seat surface by a screw, and
wherein the inlet support member is fixed to the reinforcing stay by a screw.

5. The image forming apparatus according to claim 3,
wherein the power supply includes, as the electric board, a first power supply board and a second power supply board,
wherein the power supply includes, as the board support member, a first board support member configured to support the first power supply board and a second board support member configured to support the second power supply board,
wherein the second board support member includes a fastening portion between the power supply and the casing, and
wherein the first board support member has a plate thickness relatively thinner than plate thicknesses of the inlet support member, the reinforcing stay, and the second board support member.

6. The image forming apparatus according to claim 1,
wherein the power supply includes, as the electric board, a first power supply board and a second power supply board,
wherein the power supply includes, as the board support member, a first board support member configured to support the first power supply board and a second board support member configured to support the second power supply board, and
wherein the power inlet is fixed to both of the first board support member and the second board support member.

7. The image forming apparatus according to claim 6, wherein the power supply includes the second board support member, the second power supply board, the first board support member, and the first power supply board which are horizontally stacked in the stated order.

8. The image forming apparatus according to claim 7, wherein the power supply includes a cover configured to cover the second board support member, the second power supply board, the first board support member, and the first power supply board.

9. The image forming apparatus according to claim 2,
wherein the power supply includes, as the electric board, a first power supply board and a second power supply board,
wherein the power supply includes, as the board support member, a first board support member configured to support the first power supply board, and a second board support member configured to support the second power supply board, and
wherein the power inlet is fixed to both of the first board support member and the second board support member.

10. The image forming apparatus according to claim 9, wherein the power supply includes the second board support member, the second power supply board, the first board support member, and the first power supply board which are horizontally stacked in the stated order.

11. The image forming apparatus according to claim 10, wherein the power supply includes a cover configured to cover the second board support member, the second power supply board, the first board support member, and the first power supply board.

12. The image forming apparatus according to claim 1,
wherein the power supply is fixed to the casing at a plurality of fixing points by a plurality of screws, and
wherein the power inlet is fixed to the board support member at a plurality of fixing points by a plurality of screws.

13. The image forming apparatus according to claim 2,
wherein the power supply is fixed to the casing at a plurality of fixing points by a plurality of screws, and
wherein the power inlet is fixed to the board support member at a plurality of fixing points by a plurality of screws.

14. The image forming apparatus according to claim 1, further comprising a code fixing member configured to be fixed to the inlet support member under a state in which the code fixing member holds a vicinity of an insertion portion of the power cord to be inserted to the power inlet.

15. The image forming apparatus according to claim 14, wherein the code fixing member is to be fixed to the inlet support member by a screw.

16. The image forming apparatus according to claim 1, wherein the power cord is to be fixed to the inlet support member by a screw.

17. The image forming apparatus according to claim 1, further comprising an electric component portion provided in the casing,
wherein the electric board is configured to convert the electrical power to supply the converted electrical power to the electric component portion.

18. The image forming apparatus according to claim 2, further comprising an electric component portion provided in the casing,
wherein the electric board is configured to convert the electrical power to supply the converted electrical power to the electric component portion.
